(19) United States
(12) Patent Application Publication
(10) Pub. No.: US 2010/0323186 A1
(43) Pub. Date: Dec. 23, 2010

(54) TRANSPARENT CONDUCTIVE FILM AND METHOD FOR PRODUCING TRANSPARENT CONDUCTIVE FILM

(75) Inventor: Ryuichiro Maruyama, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/795,366

(22) Filed: Jun. 7, 2010

(30) Foreign Application Priority Data
Jun. 17, 2009 (JP) P2009-143968

(51) Int. Cl. B32B 5/16; B05D 1/36; B05D 3/12

(52) U.S. Cl. 428/323; 427/331; 427/289; 977/742

(57) ABSTRACT

A transparent conductive film includes: a film base that is light transmissive, a carbon nanotube layer provided on the film base, and a metal oxide layer that is light transmissive and is deposited on the carbon nanotube layer, the metal oxide layer being provided with cracks.

### CROSS REFERENCES TO RELATED APPLICATIONS

The present application claims priority to Japanese Priority Patent Application JP 2009-143968 filed in the Japan Patent Office on Jun. 17, 2009, the entire contents of which is hereby incorporated by reference.

### BACKGROUND

The present application relates to a transparent conductive film and a method for producing a transparent conductive film, and especially to a transparent conductive film resistant to loss of conductivity and a method for producing a transparent conductive film resistant to loss of conductivity.

A transparent conductive film is used as an electrode plate on the display-surface side of a flat panel display, such as a liquid crystal display, a display using an organic electroluminescent element, or electronic paper, and is also used as an electrode plate of a touch panel disposed on the display-surface side of such a display. A transparent conductive film is required to have electrical conductivity and also be transparent, and thus is configured to include a film of a transparent conductive material on a light-transmissive film base.

In recent years, the property of being flexibly bent with respect to a flat panel display, so-called flexibility, has been required. Therefore, it has been proposed to apply a material film containing carbon nanotubes as a transparent conductive material film for use as the transparent conductive film. Further, it has also been proposed to deposit on such a material film containing carbon nanotubes a light-transmissive, conductive metal oxide layer formed of indium tin oxide (ITO), zinc oxide (ZnO), or the like (see JP-A-2005-255985, paragraph 0019, and JP-A-2008-177143, paragraph 0120). In such a laminated structure, the conductivity of the material film containing carbon nanotubes can be compensated for by the metal oxide layer.

### SUMMARY

However, a metal oxide layer has no flexibility. Therefore, when such a transparent conductive film including a metal oxide layer is bent, cracks occur in the metal oxide layer, resulting in an increase in resistance and a decrease in conductivity.

Thus, there is a need for the provision of a transparent conductive film that has flexibility together with high conductivity and also is resistant to loss of conductivity, as well as a method for producing the same.

According to an embodiment, there is provided a transparent conductive film including a film base that is light transmissive, a carbon nanotube layer provided on the film base, and a metal oxide layer that is light transmissive and is deposited on the carbon nanotube layer. In particular, the metal oxide layer is provided with cracks.

In such a transparent conductive film, the conductivity of the carbon nanotube layer is compensated for by the metal oxide layer, and thus high conductivity is achieved. Further, because cracks are preformed in the metal oxide layer, this prevents loss in conductivity due to the formation of new cracks in the metal oxide layer in case where the transparent conductive film is bent.

According to another embodiment, there is provided a method for producing a transparent conductive film, which includes the following steps. First, a carbon nanotube layer is formed on a principal surface of a light-transmissive film base. Further, a metal oxide layer is formed on the carbon nanotube layer. The film base having formed thereon the metal oxide layer is then bent to form cracks in the metal oxide layer.

A transparent conductive film having a structure according the embodiment is thus provided, where the metal oxide layer provided with cracks is deposited on the carbon nanotube layer.

As explained above, in an embodiment it is possible to prevent loss of the conductivity of a transparent conductive film having flexibility together with high conductivity.

Additional features and advantages are described herein, and will be apparent from the following Detailed Description and the figures.

### BRIEF DESCRIPTION OF THE FIGURES

FIG. 1 is a schematic sectional view showing the configuration of a transparent conductive film according to a first embodiment.

FIG. 2 is a plan view of the transparent conductive film according to the first embodiment.

FIGS. 3A to 3C show a method for producing the transparent conductive film according to the first embodiment.

FIGS. 4A to 4C are schematic sectional views showing modified embodiments of the transparent conductive film.

FIG. 5 is a plan view of a transparent conductive film according to a second embodiment.

FIG. 6 is a plan view of a transparent conductive film according to a third embodiment.

FIGS. 7A and 7B show a feature of a method for producing the transparent conductive film according to the third embodiment.

FIG. 8 is a schematic sectional view of a touch panel in which the transparent conductive film according to the third embodiment is suitable for use.

FIG. 9 is a plan view of a transparent conductive film according to a fourth embodiment.

FIGS. 10A and 10B show a feature of a method for producing the transparent conductive film according to the fourth embodiment.

FIG. 11 is a graph showing changes in resistance in relation to bending stress cycles in transparent conductive films of examples.

### DETAILED DESCRIPTION

The present application is described below in greater detail with reference to the drawings according to an embodiment.

1. First embodiment (an instance where cracks are provided to extend in two directions approximately perpendicular to each other)

2. Second embodiment (an instance where cracks provided to extend in one direction)

3. Third embodiment (an instance where cracks are provided at a marginal portion)

4. Fourth embodiment (an instance where cracks are spaced more closely in the center)

### 1. First Embodiment

### Configuration of Transparent Conductive Film

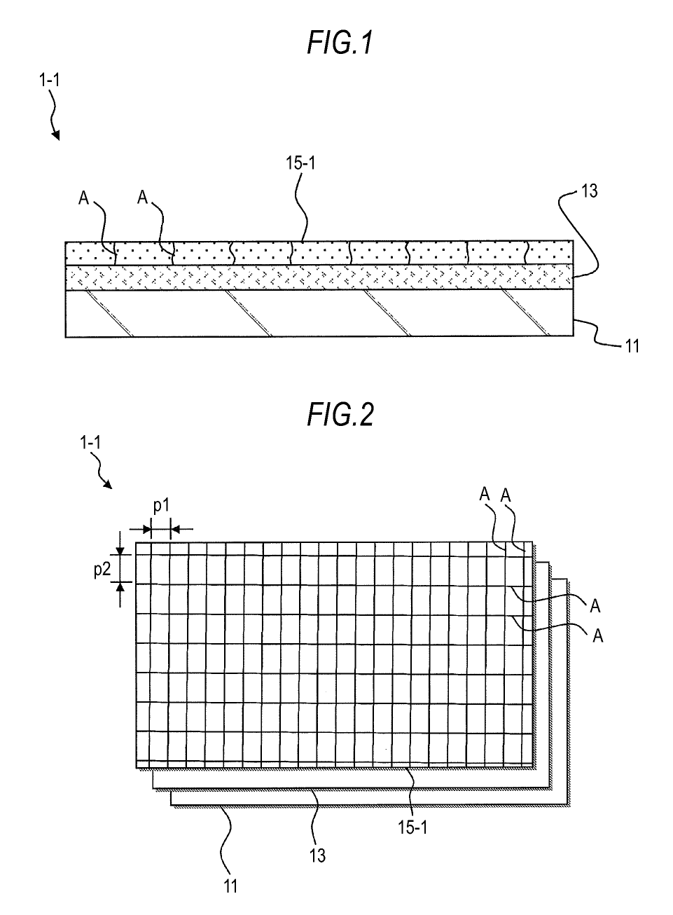

FIG. 1 is a schematic sectional view of a transparent conductive film 1-1 according to a first embodiment, and FIG. 2 is a plan view of the transparent conductive film 1-1. The transparent conductive film 1-1 of the first embodiment shown in these figures has such a configuration that a light-transmissive metal oxide layer 15-1 is deposited on a film base 11 with a carbon nanotube layer 13 in between. In particular, its characteristic is that cracks A are provided in the metal oxide layer 15-1. Hereinafter, such a metal oxide layer 15-1 having cracks A is referred to as a crack-containing metal oxide layer 15-1. Each element will be explained in detail hereinafter.

The film base 11 is a light-transmissive, flexible base, and preferably has a total light transmittance of not less than 80%. Although the material therefor is not limited, such a film base 11 may be made of a polymer material, for example. The polymer material for forming the film base 11 may be selected from highly transparent materials, such as cycloolefin polymers, as well as polycarbonate, acryl resin, polyethylene terephthalate, polyethersulfone, polyethylene naphthalate, and like polyesters. In particular, the film base 11 is preferably made of polyethylene terephthalate having excellent heat resistance and high transparency.

The film base 11 may be about 1 μm to about 500 μm thick, generally called a film, and may also be more than 500 μm and not more than 2 mm thick, generally called a sheet, for example.

The film base 11 made of a polymer material occasionally shrinks with heat, and thus is preferably pretreated with heat in order to remove such shrinkage. Further, in order to improve the adhesion to the carbon nanotube layer 13, it is preferable that such a film base 11 is previously subjected to a surface treatment such as electric discharge. Further, in order to improve adhesion, the film base 11 may have an adhesion layer formed on the surface thereof.

The carbon nanotube layer 13 is a layer formed of carbon nanotubes. The carbon nanotubes used herein are not limited. The carbon nanotubes have a diameter of about 1 to about 100 nm, and more preferably about 1.1 to about 10.0 nm. Further, the carbon nanotubes have a length of 50 to 10000 nm, and preferably 100 to 1000 nm.

The thickness of the carbon nanotube layer 13 should be suitably determined depending on the surface resistance and light transmittance required for the intended use, and is typically about 1 to about 100 nm, and the light transmittance is preferably 80 to 99%. More preferably, the thickness is about 5 to about 10 nm, and the light transmittance is about 90 to about 98%.

The crack-containing metal oxide layer 15-1 is a layer formed using a metal oxide that is light transmissive and has excellent conductivity. As the metal oxide used herein, a substance that is less susceptible to chemical changes due to humidity is preferable, examples thereof including indium oxide, tin oxide, zinc oxide, mixtures thereof, and magnesium hydroxide optionally containing carbon. A mixture of two or more of these materials may also be used. In addition, the crack-containing metal oxide layer 15-1 made of these materials may have a multilayer structure.

The thickness of the crack-containing metal oxide layer 15-1 should be suitably determined depending on the surface resistance and light transmittance required for the intended use, and is typically about 5 to about 1000 nm. In terms of light transmittance and flexibility, a thickness of 10 to 500 nm is preferable.

The cracks A provided in the crack-containing metal oxide layer 15-1 may grow in the direction of the thickness of the crack-containing metal oxide layer 15.

In particular, as shown in FIG. 2, in the crack-containing metal oxide layer 15-1 according to the first embodiment, the cracks A extend in two directions each approximately parallel to an edge of the film base 11. The intervals p1 and p2 of the cracks A are each 0.1 to 100 μm, preferably 1 to 50 μm, and more preferably about 2 to about 20 μm. Further, because the pixel pitch of a TV or a touch panel is several micrometers to several tens micrometers, it is desirable that the cracks are spaced at regular intervals of several micrometers to several tens micrometers. In the first embodiment, the cracks A are uniformly spaced over the entire surface of the crack-containing metal oxide layer 15-1.

In addition, it is preferable that the carbon nanotube layer 13 and the crack-containing metal oxide layer 15-1 are directly stacked with no adhesive or the like in between.

Method for Producing Transparent Conductive Film

The following explains a method for producing the transparent conductive film 1-1 according to the first embodiment.

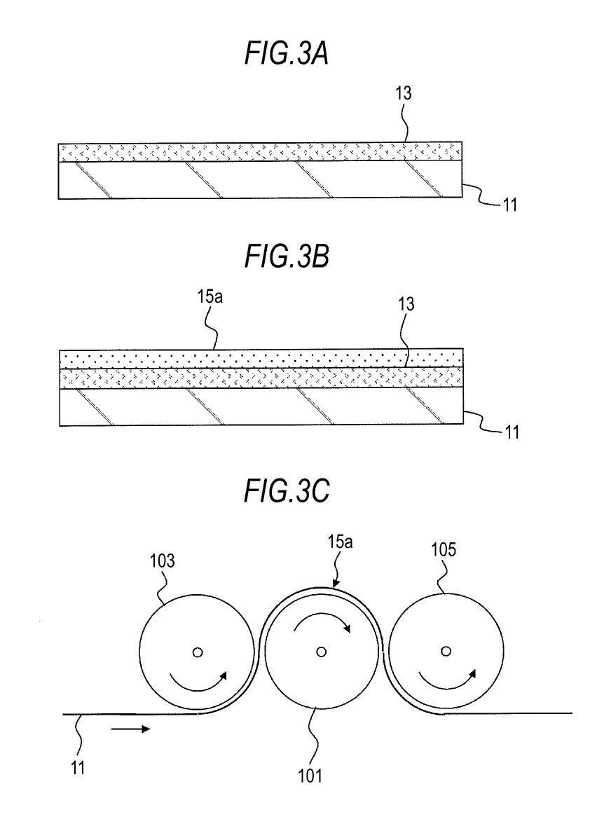

First, as shown in FIG. 3A, a film base 11 is prepared. If necessary, the film base 11 is subjected to a heat treatment, and then a surface treatment (e.g., electric discharge) is applied thereto to improve the adhesion to an upper layer, or alternatively, an adhesion layer is formed. On the treated surface of the film base 11, a carbon nanotube layer 13 is formed.

The carbon nanotube layer 13 is formed as follows. First, a carbon nanotube dispersion having carbon nanotubes dispersed in a dispersion solvent is prepared. Examples of dispersion solvents include dispersant-containing water, alcoholic solutions, and organic liquids. The dispersant helps the dispersion of carbon nanotubes that are originally difficult to disperse in water or alcohol, allowing an excellent dispersion state. Examples of usable dispersants include anionic dispersants such as Sodium Dodecylsulphate (SDS), sodium dodecylbenzene sulfonate (SDBS), sodium dodecylsulfonate (SDSA), sodium n-lauroylsarcosine (Sarkosyl), and sodium alkyl allyl sulfosuccinate (TREM), and nonionic dispersants such as polyoxyethylene lauryl ether, polyoxyethylene cetyl ether, polyoxyethylene stearyl ether, polyoxyethylene oleyl ether, polyoxyethylene cetyl ether, polyoxyethylene stearyl ether, polyoxyethylene oleyl ether, polyoxyethylene stearyl ether, polyoxyethylene isooctylphenyl ether (Triton X-405: trade name), polyoxyethylene (20) sorbitan monolaurate (Tween 20: trade name), and polyoxyethylene (20) sorbitan trioleate (Tween 85: trade name). The dispersion solvent may also be an organic liquid. Specifically, the dispersion solvent may be a liquid containing one or more organic solvents such as ethanol, methanol, chloroform, dimethylformamide, N-methyl-2-pyrrolidone, 1,2-dichlorobenzene, dichloroethane, IPA, and γ-butyrolactone.

Next, the prepared carbon nanotube dispersion is applied to the treated surface of the film base 11 (coating). The application method is not limited, and a preferred method is one that allows the application to give a film of uniform thickness regardless of the area of the film base 11. Subsequently, the dispersion solvent in the applied film is removed by drying to give a carbon nanotube layer 13 formed of carbon nanotubes. When a dispersant-containing aqueous liquid is used as the dispersion solvent for the carbon nanotube dispersion, the removal of the dispersion solvent by drying is followed by washing with water. The dispersant remaining in the carbon nanotube layer 13 is thus removed, thereby improving the conductivity of carbon nanotubes.

The method for forming the carbon nanotube layer 13 is not limited to the above. For example, it is also possible to spray a carbon nanotube dispersion or employ electrodeposition.

Subsequently, as shown in FIG. 3B, a metal oxide layer 15a is formed on the carbon nanotube layer 13. The metal oxide layer 15a is formed by a film formation method suitably selected from vacuum deposition called physical vapor deposition (PVD method), such as electron beam deposition or sputtering; chemical vapor deposition (CVD method); and the like.

Subsequently, a treatment for forming cracks A in the metal oxide layer 15a is applied as shown in FIG. 3C. Here, the film base 11 having formed thereon the metal oxide layer 15a is fed along the outer side wall of a cylinder 101 that rotates in the circumferential direction. At this time, the film base 11 is inserted between the cylinder 101 and two guide cylinders 103 and 105 provided parallel to the cylinder 101 in such a manner that the metal oxide layer 15a is outside the film base 11 on the outer side wall of the cylinder 101. The entire surface of the film base 11 is thereby bent with uniform curvature along the outer side wall of the cylinder 101. Thus, in the metal oxide layer 15a that is outside the film base 11, cracks A are formed in the direction approximately perpendicular to the circumferential direction of the cylinder 101. The cracks A thus formed are at practically regular intervals. At this time, the film base 11 is positioned in such a manner that one pair of opposite edges thereof are parallel to the rotation direction of the cylinder 101, and the edges perpendicular thereto are along the height direction of the cylinder 101. The cracks A can thus be provided to extend parallel to edges of the film base 11.

Cracks A are formed in this manner in two directions of the film base 11. As a result, as explained with reference to FIG. 2, the crack-containing metal oxide layer 15-1 having cracks A extending in two directions each approximately parallel to an edge of the film base 11 can be obtained. In the formation of the cracks A in two directions of the film base 11, by suitably adjusting the curvature of the cylinder 101, the intervals p1 and p2 of the cracks A in two directions can be independently determined.

Such a transparent conductive film 1-1 is applied, for example, as a light-extraction-side electrode plate of a flexibly bendable, flat panel display, and is further used as an electrode plate of a touch panel disposed on the display-surface side of such a display. In addition, it is also employed as a shielding film of a liquid crystal display or as an electrode plate of a solar cell.

In such a transparent conductive film 1-1, the conductivity of the carbon nanotube layer 13 is compensated for by the crack-containing metal oxide layer 15-1, and thus high conductivity is achieved. Further, because the cracks are preformed in the crack-containing metal oxide layer 15-1, this prevents the formation of new cracks in the metal oxide layer in case where the transparent conductive film 1-1 is bent, thereby preventing loss of conductivity. As a result, in the transparent conductive film 1-1 having flexibility together with high conductivity, loss of conductivity can be prevented.

Further, the transparent conductive film 1-1 has the crack-containing metal oxide layer 15-1 over the entire surface thereof. Therefore, as compared with the configuration where a metal oxide having excellent conductivity is dispersed in the form of particles in a carbon nanotube layer, because of the absence of light scattering on the particle surface, the light-transmitting property can also be maintained.

### Alternative Embodiments

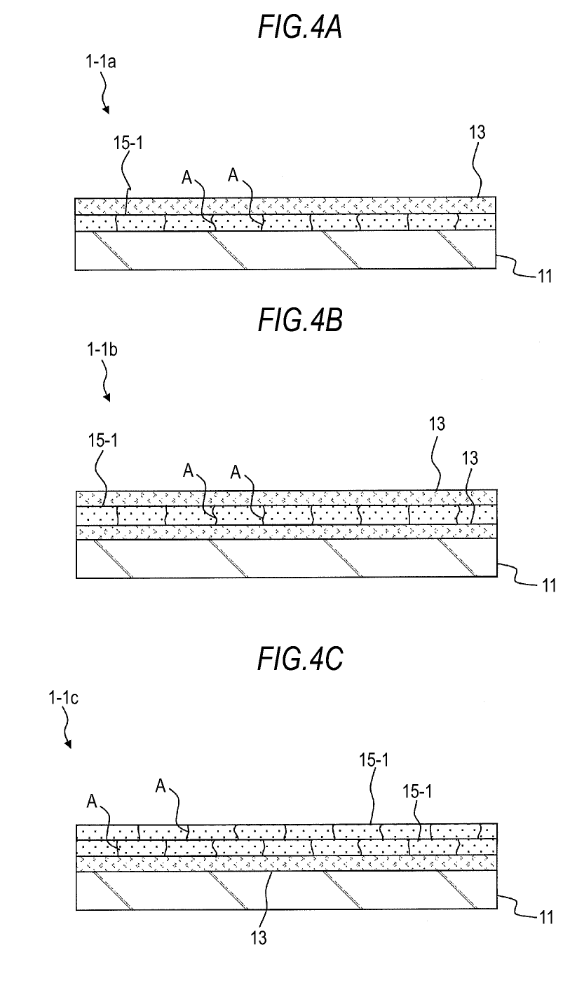

Such a transparent conductive film 1-1 having the crack-containing metal oxide layer 15-1 may have various laminated structures as shown in FIGS. 4A to 4C, for example.

A transparent conductive film 1-1a according to an alternative embodiment shown in FIG. 4A has such a configuration that a crack-containing metal oxide layer 15-1 and a carbon nanotube layer 13 are deposited in this order on a film base 11. The transparent conductive film 1-1a is produced through the following steps. 1) A metal oxide layer is formed on the film base 11. 2) Cracks A are formed in the metal oxide layer. 3) A carbon nanotube layer 13 is formed. The step 2) of forming of cracks may be performed after the step 3) of forming a carbon nanotube layer 13. Each step is carried out in the same manner as explained in the first embodiment with reference to FIGS. 3A to 3C.

A transparent conductive film 1-1b according to an alternative embodiment shown in FIG. 4B has such a configuration that a carbon nanotube layer 13, a crack-containing metal oxide layer 15-1, and a carbon nanotube layer 13 are deposited in this order on a film base 11. The transparent conductive film 1-1b is produced through the following steps. 1) A carbon nanotube layer 13 is formed on the film base 11. 2) A metal oxide layer is formed. 3) Cracks A are formed in the metal oxide layer. 4) Another carbon nanotube layer 13 is formed. The step 3) of forming cracks A may be performed after the step 4) of forming a carbon nanotube layer 13. Each step is carried out in the same manner as explained in the first embodiment with reference to FIGS. 3A to 3C.

A transparent conductive film 1-1c according to an alternative embodiment shown in FIG. 4C has such a configuration that a carbon nanotube layer 13, a first crack-containing metal oxide layer 15-1, and a second crack-containing metal oxide layer 15-1 are deposited in this order on a film base 11. Cracks A in the first crack-containing metal oxide layer 15-1 and cracks A in the second crack-containing metal oxide layer 15-1 may be in communication with each other in the depth direction or may also be not in communication. Further, the intervals p1 and p2 may differ. The transparent conductive film 1-1c is produced through the following steps. 1) A carbon nanotube layer 13 is formed on the film base 11. 2) A first metal oxide layer is formed. 3) Cracks A are formed in the first metal oxide layer. 4) A second metal oxide layer is formed. 5) Cracks A are formed in the second metal oxide layer. Alternatively, without the step 3) of forming cracks, the step 5) of forming cracks may be performed after successively performing the steps 2) and 4) of forming metal oxide layers using different materials.

In addition, the two crack-containing metal oxide layers 15-1 may be stacked with a carbon nanotube layer 13 in between.

The transparent conductive films 1-1a to 1-1c as above may be used in combination, and a plurality of carbon nanotube layers 13 and a plurality of crack-containing metal oxide layers 15-1 may be deposited in a suitable order.

In such transparent conductive films of the alternative embodiments, when the topmost surface thereof has a carbon nanotube layer 13, such a carbon nanotube layer 13 serves as a protective layer, and the crack-containing metal oxide layer 15-1 can thus be chemically stabilized. Therefore, this is even more effective in preventing loss of conductivity.

### Second Embodiment

### Configuration of Transparent Conductive Film

FIG. 5 is a plan view of a transparent conductive film 1-2 according to a second embodiment. The difference between the transparent conductive film 1-2 of the second embodiment shown in the figure and the transparent conductive film 1-1 of the first embodiment is the arrangement of cracks A in a crack-containing metal oxide layer 15-2, and the configuration is otherwise the same. The redundant description is thus omitted.

That is, in the crack-containing metal oxide layer 15-2 according to the second embodiment, cracks A extend in one direction approximately parallel to an edge of the film base 11. As in the first embodiment, the intervals p1 of the cracks A are each 0.1 to 100 μm, preferably 1 to 50 μm, and more preferably about 2 to about 20 μm, and the cracks A are uniformly spaced over the entire surface of the crack-containing metal oxide layer 15-1.

Method for Producing Transparent Conductive Film

The method for producing the transparent conductive film 1-2 of the second embodiment is the same as explained in the first embodiment with reference to FIGS. 3A to 3C, expect that the cracks A are formed only in one direction of the film base 11.

Such a transparent conductive film 1-2 is applied, for example, as a light-extraction-side electrode plate of a flexibly bendable, flat panel display, and is further used as an electrode plate of a touch panel disposed on the display-surface side of such a display. In addition, it is also employed as a shielding film of a liquid crystal display or as an electrode plate of a solar cell. In particular, when the film is applied in a display whose display surface is wound for storage, the cracks A are provided to extend perpendicularly to the winding direction.

Even in such a transparent conductive film 1-2, the conductivity of the carbon nanotube layer 13 is compensated for by the crack-containing metal oxide layer 15-2, and thus high conductivity is achieved. Further, because the cracks A are preformed in the crack-containing metal oxide layer 15-2, this prevents the formation of new cracks in the metal oxide layer in case where the transparent conductive film 1-2 is bent in a direction perpendicular to the direction of extension of the cracks A, thereby preventing loss of conductivity. That is, even when the transparent conductive film 1-2 is wound up in the direction perpendicular to the direction in which the cracks A extend, loss of conductivity can prevented. As a result, in the transparent conductive film 1-2 having flexibility together with high conductivity, loss of conductivity can be prevented.

Further, as in the first embodiment, the transparent conductive film 1-2 also has the crack-containing metal oxide layer 15-2 over the entire surface thereof, and therefore, as compared with the configuration where a metal oxide is dispersed in the form of particles in the carbon nanotube layer, the light-transmitting property can also be maintained.

### Modified Embodiments

Such a transparent conductive film 1-2 having the crack-containing metal oxide layer 15-2 may also have various laminated structures as explained in the first embodiment with reference to FIGS. 4A to 4C, and the same effects can be achieved.

Further, in the configuration where two crack-containing metal oxide layers 15-2 are deposited, cracks A formed in the first crack-containing metal oxide layer 15-2 and cracks A formed in the second crack-containing metal oxide layer 15-2 may be provided to extend in directions approximately perpendicular to each other.

### Third Embodiment

### Configuration of Transparent Conductive Film

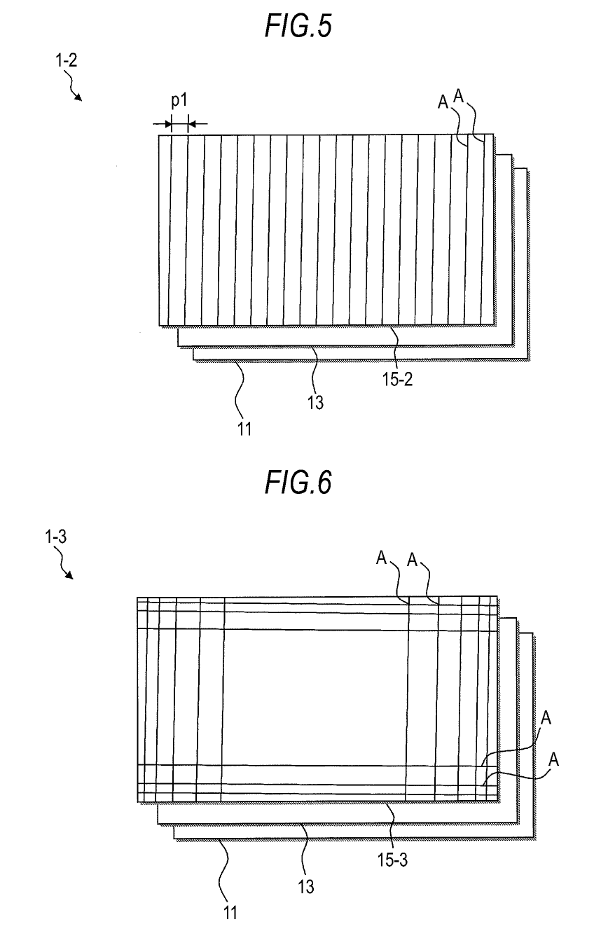

FIG. 6 is a plan view of a transparent conductive film 1-3 according to a third embodiment. The difference between the transparent conductive film 1-3 of the third embodiment shown in the figure and the transparent conductive film 1-1 of the first embodiment is the arrangement of cracks A in a crack-containing metal oxide layer 15-3, and the configuration is otherwise the same. The redundant description is thus omitted.

That is, in the crack-containing metal oxide layer 15-3 according to the third embodiment, cracks A extending approximately parallel to an edge of the film base 11 are spaced more closely at the edges of the film base 11 than in the center thereof. Here, especially, the cracks A extending in two directions each approximately parallel to an edge are provided only at the edges of the film base 11. The intervals of the cracks A at the edges of the film base 11 are each 0.1 to 100 preferably 1 to 50 and more preferably about 2 to about 20 and the density of the cracks A may be reduced in the direction toward the center.

Method for Producing Transparent Conductive Film

The method for producing the transparent conductive film 1-3 according to the third embodiment is different from the production method explained in the first embodiment with reference to FIGS. 3A to 3C in the step of forming cracks A. The method is as follows.

First, in the same manner as explained in the first embodiment with reference to FIG. 3A, a carbon nanotube layer 13 is formed on a film base 11. Further, a metal oxide layer 15a is formed in the same manner as explained with reference to FIG. 3B.

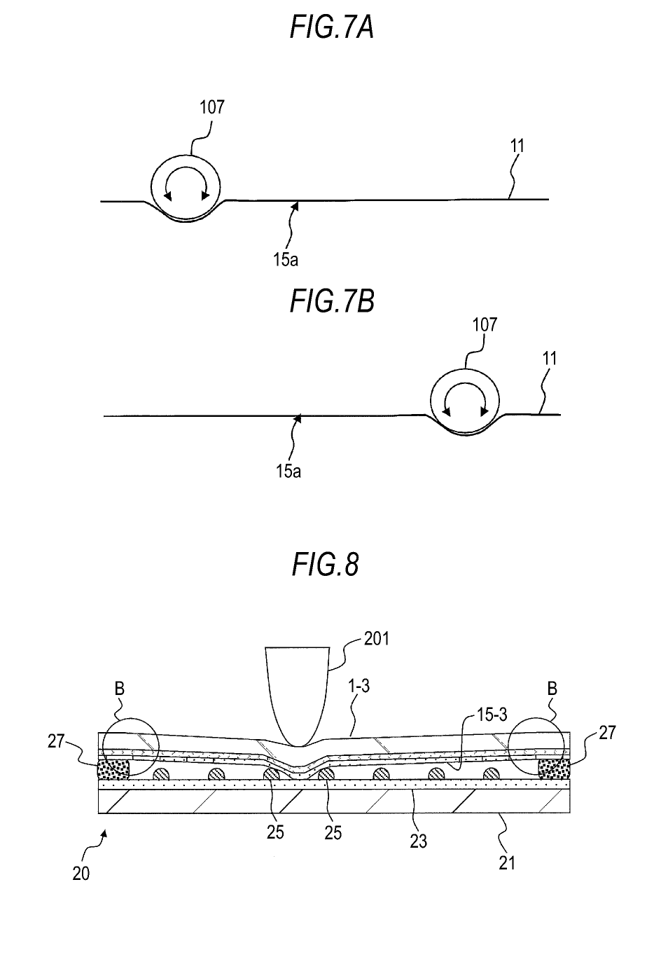

Subsequently, as shown in FIGS. 7A and 7B, a treatment for forming cracks A in the metal oxide layer 15a is applied. First, as shown in FIG. 7A, a cylinder 107 is pressed against the film base 11 having formed thereon the metal oxide layer 15a from the film-base-11 side so as to bend the film base 11 along the side wall portion of the cylinder 107. Thus, in the metal oxide layer 15a that is outside the film base 11, cracks A are formed in the direction approximately perpendicular to the circumferential direction of the cylinder 107. The cracks A thus formed are spaced more closely in the center of the bent portion. Further, as shown in FIG. 7B, the cylinder 107 is moved relative to the film base 11. In the moved position, the cylinder 107 is pressed against the film base 11 having formed thereon the metal oxide layer 15a from the film-base-11 side to form cracks A.

Cracks A are formed in this manner in two directions of the film base 11.

Subsequently, in agreement with the positions where the cracks A are formed, the film base 11 is cut in two directions along the direction of extension of the cracks A. This provides, as shown in FIG. 6, the crack-containing metal oxide layer 15-3 in which cracks A extending along an edge are provided only at the edges of the film base 11.

Such a transparent conductive film 1-3 may be used for the same applications as in the first embodiment, and is particularly suitable for use as an electrode plate of a touch panel.

Even in such a transparent conductive film 1-3, the conductivity of the carbon nanotube layer 13 is compensated for by the crack-containing metal oxide layer 15-3, and thus high conductivity is achieved. Further, because the cracks A are preformed at the edges of the crack-containing metal oxide layer 15-3, this prevents the formation of new cracks in the metal oxide layer in case where a bending stress is applied to the edges of the transparent conductive film 1-3, thereby preventing loss of conductivity.

Such a transparent conductive film 1-3 is suitable for use as an electrode plate of a touch panel disposed on the display-surface side of a display.

FIG. 8 shows a schematic sectional view of a touch panel 20 that employs the transparent conductive film 1-3. Dot spacers 25 are disposed on a supporting substrate 21 of the touch panel 20 with a transparent conductive film 23 in between. On the transparent-conductive-film-23 side of the supporting substrate 21, the transparent conductive film 1-3 is disposed in an opposing manner with the crack-containing metal oxide layer 15-3 inside. The supporting substrate 21 and the transparent conductive film 1-3 are bonded together using a bonding agent 27 provided on the margin.

In such a touch panel 20, when a pressure is applied by a touch pen 201 or the like thereto from the transparent-conductive-film-1-3 side, the flexible transparent conductive film 1-3 sags. As a result, the crack-containing metal oxide layer 15-3 on the transparent-conductive-film-1-3 side comes in contact with the transparent conductive film 23 on the supporting-substrate-21 side, and current thus flows. By detecting the electric potentials in four directions, the portion pressed by the touch pen 201 is specified.

When a pressure is applied to the transparent conductive film 1-3 by the touch pen 201, no matter where the touch pen 201 presses, the margin B of the transparent conductive film 1-3 always receives a bending stress. However, by providing the transparent conductive film 1-3 of the third embodiment as shown in FIG. 6, new cracks are not formed at the marginal portion of the crack-containing metal oxide layer 15-3, and this prevents loss of the conductivity of the transparent conductive film 1-3.

### Modified Embodiments

Such a transparent conductive film 1-3 having the crack-containing metal oxide layer 15-3 may also have various laminated structures as explained in the first embodiment with reference to FIGS. 4A to 4C, and the same effects can be achieved.

### Fourth Embodiment

### Configuration of Transparent Conductive Film

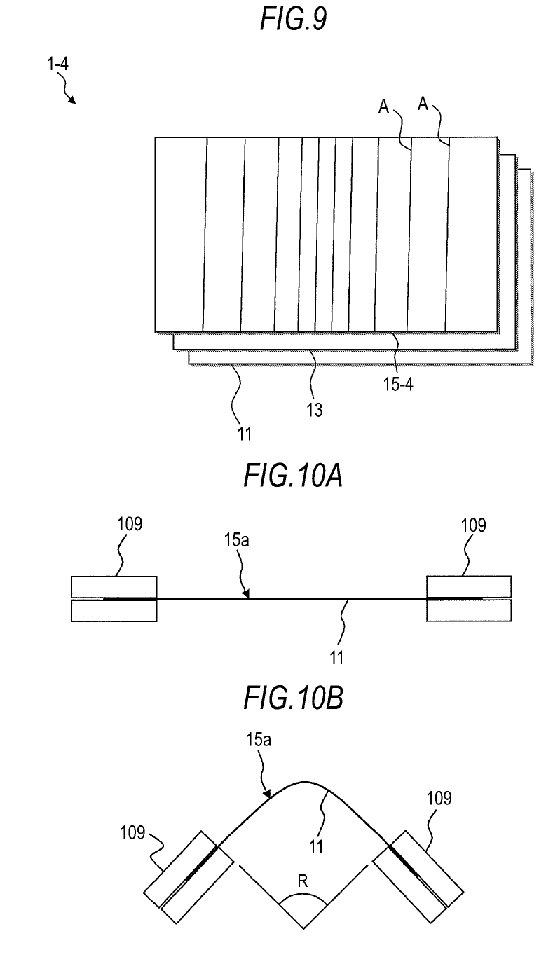

FIG. 9 is a plan view of a transparent conductive film 1-4 according to a fourth embodiment. The difference between the transparent conductive film 1-4 of the fourth embodiment shown in the figure and the transparent conductive film 1-1 of the first embodiment is the arrangement of cracks A in a crack-containing metal oxide layer 15-4, and the configuration is otherwise the same. The redundant description is thus omitted.

That is, in the crack-containing metal oxide layer 15-4 according to the fourth embodiment, cracks A extending approximately parallel to an edge of the film base 11 are spaced more closely in the center of the film base 11 than at the edges. Here, especially, the cracks A are provided only in one direction approximately parallel to an edge. The intervals of the cracks A in the center of the film base 11 are each 0.1 to 100 μm, preferably 1 to 50 μm, and more preferably about 2 to about 20 μm, and the density of the cracks A is reduced in the direction toward the edges.

Method for Producing Transparent Conductive Film

The method for producing the transparent conductive film 1-4 according to the fourth embodiment is different from the production method explained in the first embodiment with reference to FIGS. 3A to 3C in the step of forming cracks A. The method is as follows.

First, in the same manner as explained in the first embodiment with reference to FIG. 3A, a carbon nanotube layer 13 is formed on a film base 11, and a metal oxide layer 15a is formed in the same manner as explained with reference to FIG. 3B.

Subsequently, as shown in FIGS. 10A and 10B, a treatment for forming cracks A in the metal oxide layer 15a is provided. First, as shown in FIG. 10A, opposite edges of the film base 11 having formed thereon the metal oxide layer 15a are fixed to fixing jigs 109. Subsequently, as shown in FIG. 10B, the film base 11 is bent at the center by turning the two fixing jigs 109. At this time, the metal oxide layer 15a on the film base 11 is on the outside of the bent surface. Cracks A are thus formed in the metal oxide layer 15a outside the film base 11 in the direction approximately perpendicular to the bending direction of the film base 11. The cracks A thus formed are spaced more closely in the center of the film base 11 (i.e., center of the bent portion).

Accordingly, as explained with reference to FIG. 9, the crack-containing metal oxide layer 15-4 having cracks A that are spaced more closely in the center of the film base 11 can be obtained. In addition, in the case of forming cracks A in two directions of the film base 11, the bending of the film base 11 is given in two directions. Further, by adjusting the degree of bending (e.g., curvature radius R) of the film base 11, the intervals of the cracks A can be independently determined.

Such a transparent conductive film 1-4 is applied, for example, as a light-extraction-side electrode plate of a flexibly bendable, flat panel display, and is further used as an electrode plate of a touch panel disposed on the display-surface side of such a display. In addition, it is also used as a shielding film of a liquid crystal display or as an electrode plate of a solar cell. In particular, when the film is applied in a display whose display surface is wound for storage, the cracks A are provided to extend perpendicularly to the winding direction.

Even in such a transparent conductive film 1-4, the conductivity of the carbon nanotube layer 13 is compensated for by the crack-containing metal oxide layer 15-4, and thus high conductivity is achieved. Further, because the cracks A are preformed in the crack-containing metal oxide layer 15-4, this prevents the formation of new cracks in the metal oxide layer in case where the transparent conductive film 1-4 is bent in a direction perpendicular to the direction of extension of the cracks A, thereby preventing loss of conductivity. That is, even when the transparent conductive film 1-4 is bent in the direction perpendicular to the direction in which the cracks A extend, loss of conductivity can prevented. As a result, in the transparent conductive film 1-4 having flexibility together with high conductivity, loss of conductivity can be prevented.

Further, as in the first embodiment, the transparent conductive film 1-4 also has the crack-containing metal oxide layer 15-4 over the entire surface thereof, and therefore, as compared with the configuration where a metal oxide is dispersed in the form of particles in the carbon nanotube layer, the light-transmitting property can also be maintained.

### Modified Embodiments

Such a transparent conductive film 1-4 having the crack-containing metal oxide layer 15-4 may also have various laminated structures as explained in the first embodiment with reference to FIGS. 4A to 4C, and the same effects can be achieved.

Further, in the configuration where two crack-containing metal oxide layers 15-4 are deposited, cracks A formed in the first crack-containing metal oxide layer 15-4 and cracks A formed in the second crack-containing metal oxide layer 15-4 may be provided to extend in directions approximately perpendicular to each other.

### EXAMPLES

### Example 1

A transparent conductive film 1-1a with the layer structure shown in FIG. 4A was produced as follows.

First, on a film base 11 made of polyethylene terephthalate (PET), a metal oxide layer 15a made of ITO having a sheet resistance of 25 Ω/square was formed by sputtering. The film base 11 was then cut to a size of 3 cm×3 cm.

Subsequently, carbon nanotubes (manufactured by Carbon Solutions, Inc.) were dispersed in a 1 wt % aqueous sodium lauryl sulfate (SDS) solution to a concentration of 0.1 mg/ml, thereby preparing a carbon nanotube dispersion. The obtained carbon nanotube dispersion was applied onto the metal oxide layer 15a, and then dried. This procedure was repeated four times to form a carbon nanotube layer 13.

Subsequently, as shown in FIGS. 10A and 10B, a bending stress with a curvature radius R of 10 mm was repetitively applied thereto 2000 times. Cracks A were thus formed in the metal oxide layer 15a such that they were spaced more closely in the center as shown in FIG. 9, thereby giving a transparent conductive film 1-4. However, the laminated structure thereof is that of the transparent conductive film 1-1a with the layer structure shown in FIGS. 4A to 4C.

### Comparative Example 1

The procedure of Example 1 was repeated, but cracks A were not formed, thereby giving a transparent conductive film having a carbon nanotube layer 13 formed on a film base 11 with a metal oxide layer 15a in between, the metal oxide layer 15a having no cracks A.

### Comparative Example 2

The procedure of Example 1 was repeated, but only the formation of the metal oxide layer 15a was employed, thereby giving a transparent conductive film only having a metal oxide layer 15a on the film base 11, the metal oxide layer 15a having no cracks A.

Evaluation 1

With respect to the transparent conductive films of Example 1 and Comparative Examples 1 and 2, the light transmittance at a wavelength of 550 nm was measured. The results are shown in the following Table 1.

TABLE 1

| | | Comparative | Comparative |
|---|---|---|---|
| | Example 1 | Example 1 | Example 2 |
| Light transmittance | 90% | 90% | 95% |
| (wavelength: 550 nm) | | | |

The results shown in Table 1 indicate the following. In Example 1 where the application was applied, the light transmittance is lower than in Comparative Example 2 where only the metal oxide layer with no cracks was provided; however, the light transmittance of Example 1 is as high as that of Comparative Example 1 where the metal oxide layer with no cracks was deposited on the carbon nanotube layer.

Evaluation 2

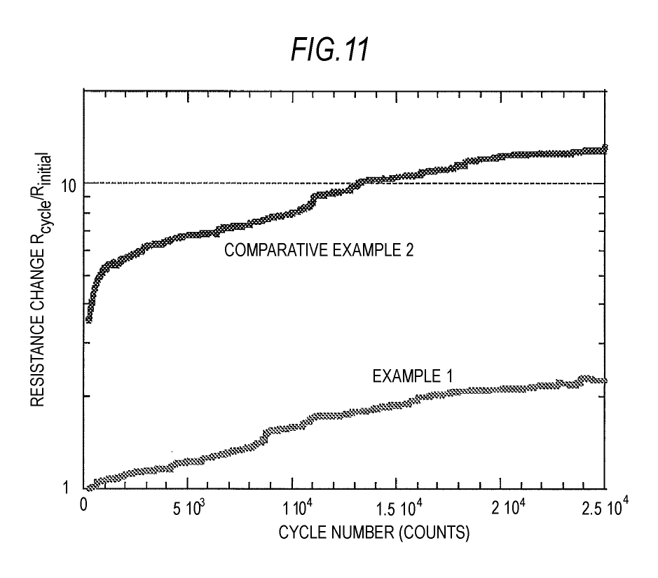

Changes in characteristics of a transparent conductive film due to a mechanical stress were measured. A bending stress was applied to the transparent conductive films produced in Example 1 and Comparative Example 2, and changes in resistance were measured. At this time, as shown in FIGS. 10A and 10B, each transparent conductive film was fixed between two fixing jigs 109 that serve as electrodes. Between the electrodes (fixing jigs 109), the width was 1 cm, and the length was about 2 cm. In this state, a bending stress was applied to each transparent conductive film with a maximum curvature radius R of about 8 mm and a cycle period of 0.4 Hz at a fixed voltage of 3V between the electrodes, and the resistance was measured. The results are shown in FIG. 11 as the values of the resistance per cycle (R_{cycle}) relative to the initial resistance (Rᵢₙᵢₜᵢₐₗ).

According to the results shown in FIG. 11, in Comparative Example 2 where the metal oxide layer with no cracks was employed, the resistance (R_{cycle}) increases 10 times greater than the initial resistance (Rᵢₙᵢₜᵢₐₗ) in about 13000 cycles. In contrast, in Example 1 where the application was applied and the crack-containing metal oxide layer was employed, even after 20000 cycles, the resistance change (R_{cycle/initial}) provides only about two- or three-fold increase. This therefore indicates that the provision of the crack-containing metal oxide layer improves durability under mechanical stress.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A transparent conductive film comprising:
a film base that is light transmissive,
a carbon nanotube layer provided on the film base, and
a metal oxide layer that is light transmissive and is deposited on the carbon nanotube layer,
the metal oxide layer being provided with cracks.

2. A transparent conductive film according to claim 1, wherein
the cracks extend approximately parallel to an edge of the film base.

3. A transparent conductive film according to claim 1 or 2, wherein
the cracks extend in two directions approximately perpendicular to each other.

4. A transparent conductive film according to claim 1, wherein
at an edge of the film base, the cracks that extend approximately parallel to the edge are spaced more closely than in the center of the film base.

5. A transparent conductive film according to claim 1, further comprising
at lease one additional nanotube layer and/or at lease one additional metal oxide layer.

6. A method for producing a transparent conductive film, comprising:
forming a carbon nanotube layer on a principal surface of a film base that is light transmissive,
forming a metal oxide layer on the carbon nanotube layer, and
forming cracks in the metal oxide layer by bending the film base having formed thereon the metal oxide layer.

7. A method for producing a transparent conductive film according to claim 6, wherein
the step of forming cracks is performed after forming the carbon nanotube layer on the film base.

8. A method for producing a transparent conductive film according to claim 7, wherein
in the step of forming cracks, the film base having formed thereon the metal oxide layer is fed along a side wall of a cylinder to successively bend the entire film base, thereby forming the cracks.

9. A method for producing a transparent conductive film according to claim 7, wherein
in the step of forming cracks, a cylinder-like side wall portion is pressed against the film base having formed thereon the metal oxide layer to cause bending, thereby forming the cracks at a predetermined portion of the metal oxide layer.

10. A method for producing a transparent conductive film according to claim 9, wherein
the film base is cut so that the cracks are present at an edge thereof.
